(19) United States
(12) Patent Application Publication
(10) Pub. No.: US 2015/0285140 A1
(43) Pub. Date: Oct. 8, 2015

(54) THERMAL INSULATION COATING COMPOSITION AND THERMAL INSULATION COATING LAYER

(71) Applicant: Hyundai Motor Company, Seoul (KR)

(72) Inventors: Jiyoun Seo, Suwon (KR); Woongpyo Hong, Seoul (KR); Seungwoo Lee, Seoul (KR); Bokyung Kim, Yongin (KR); Inwoong Lyo, Suwon (KR); Kwanghoon Choi, Yongin (KR); Hongkil Baek, Seoul (KR)

(21) Appl. No.: 14/582,698

(22) Filed: Dec. 24, 2014

(30) Foreign Application Priority Data
Dec. 31, 2013 (KR) 10-2013-0168496

(51) Int. Cl. F02B 77/11; C09D 179/08

(52) U.S. Cl. CPC F02B 77/11; C09D 179/08

(57) ABSTRACT

Disclosed are a thermal insulation coating composition that includes a solvent dispersion of a polyamideimide resin and a solvent dispersion of an aerogel and a thermal insulation coating layer that is obtained from the thermal insulation coating composition.

### CROSS REFERENCE TO RELATED APPLICATION

The present application claims priority to Korean Patent Application No. 10-2013-0168496 filed on Dec. 31, 2013, the entire contents of which is incorporated herein for all purposes by this reference.

### TECHNICAL FIELD

The present invention relates to a thermal insulation coating composition and a thermal insulation coating layer. Particularly, the thermal insulation coating composition may have reduced thermal conductivity and reduced volumetric thermal capacity, thereby providing improved mechanical physical properties and thermal resistance. As such, the thermal insulation coating layer obtained from the coating composition may be applied to an internal combustion engine to reduce thermal energy discharged to the outside, thereby improving efficiency of the internal combustion engine and fuel efficiency of a vehicle.

### BACKGROUND

An internal combustion engine generally refers to an engine in which combustion gas generated by combustion of fuels works directly on piston, turbine blade, or the like, to convert thermal energy of the fuel into a mechanical work. The internal combustion engine is generally referred to as a reciprocating type engine in which gas mixture of fuel and air is ignited and exploded in cylinder to move the piston. For example, gas turbine, jet engine, rocket, and the like, may be also included in the internal combustion engine.

The internal combustion engine may be classified into a gas engine, a gasoline engine, a petroleum engine, a diesel engine, and the like, depending on fuel types. The petroleum engine, gas engine and the gasoline engine are ignited by an electrical arc by spark plug, and the diesel engine is naturally ignited by spraying the fuel in high temperature and high pressure air. The internal combustion engine may also be classified into four-stroke and two-stroke cycle types depending on stroke operation of the piston.

The internal combustion engine of the vehicle has thermal efficiency of about 15% to 35%. However, even in the internal combustion engine having maximum efficiency, about 60% or greater of the entire thermal energy may be consumed by thermal energy discharged to the outside through wall of the internal combustion engine, exhaust gas, and the like.

Accordingly, when reducing an amount of the thermal energy discharged to the outside through the wall of the internal combustion engine, efficiency of the internal combustion engine may be increased, such that methods of installing insulation materials on the outside of the internal combustion engine, changing materials or portions of a structure of the internal combustion engine, or developing cooling systems of the internal combustion engine have been developed.

In particular, when minimizing the discharge of heat generated in the internal combustion engine through the wall of the internal combustion engine to the outside, efficiency of the internal combustion engine and fuel efficiency of the vehicle may be improved. However, thermal insulation materials, thermal insulation structures, and the like that may be maintained in the internal combustion engine under repeated high temperature and high pressure conditions for an extended time have not been developed suitably.

The description provided above as a related art of the present invention is just merely for helping understanding of the background of the present invention and should not be construed as being included in the related art known by those skilled in the art.

### SUMMARY OF THE INVENTION

In a preferred aspect, the present invention provides a thermal insulation coating composition and a thermal insulation coating layer. The thermal insulation coating composition may have reduced thermal conductivity and reduce volumetric thermal capacity in addition to substantially improved mechanical physical properties and thermal resistance. Accordingly, the thermal insulation coating layer obtained from the thermal insulation coating composition may be applied to an internal combustion engine to reduce thermal energy discharged to the outside, thereby improving efficiency of the internal combustion engine and fuel efficiency of a vehicle.

In one aspect, provided is a thermal insulation coating composition that may include: a polyamideimide resin dispersed in a first organic solvent or in an aqueous solvent; and an aerogel dispersed in a second point organic solvent. In particular, the first organic solvent may have a boiling point equal to or greater than about 110° C. Further, the second organic solvent may have a boiling temperature less than about 110° C. In addition, the term “aqueous solvent” may include water content greater than about 50% by volume, greater than about 55% by volume, greater than about 60% by volume, greater than about 65% by volume, greater than about 70% by volume, greater than about 75% by volume, greater than about 80% by volume, greater than about 85% by volume, greater than about 90% by volume, greater than about 95% by volume, or greater than about 99% by volume, based on the total volume of the solvent system.

The thermal insulation coating composition may be used for coating inner surfaces or components of an internal combustion engine.

The polyamideimide resin may have a weight average molecular weight of about 3,000 to 100,000.

The aerogel may include at least one kind compound selected from the group consisting of silicon oxide, carbon, polyimide, and metal carbide.

The aerogel may have a specific surface area from about 100 cm²/g to about 1,000 cm²/g.

The aerogel may be included in an amount of about 5 to 50 parts by weight based on 100 parts by weight of the polyamideimide resin.

The polyamideimide resin in the high boiling point organic solvent or in the aqueous solvent may have a solid content of about 5 wt % to 75 wt %, based on the total weight of 1) the high boiling point organic solvent or the aqueous solvent and 2) the polyamideimide resin.

The aerogel in the low boiling point organic solvent may have a solid content of about 5 wt % to 75 wt %, based on the total weight of the aerogel and the low boiling point organic solvent.

A difference in boiling point between the first organic solvent and the second organic solvent may be about 10° C. or greater.

The first organic solvent may include at least one selected from the group consisting of anisole, toluene, xylene, methyl ethyl ketone, methyl isobutyl ketone and ethylene glycol monomethyl ether, ethylene glycol monoethyl ether, ethylene glycol monobutyl ether, butyl acetate, cyclohexanone, ethylene glycol monoethyl ether acetate (BCA), benzene, hexane, and N,N′-dimethylformamide.

The second organic solvent may include at least one selected from the group consisting of methyl alcohol, ethyl alcohol, propyl alcohol, n-butyl alcohol, iso-butyl alcohol, tert-butyl alcohol, acetone, methylene chloride, ethylene acetate and isopropyl alcohol.

The aqueous solvent may include at least one selected from the group consisting of water, methanol, ethanol and ethyl acetate.

In another aspect, also provided is a thermal insulation coating layer including a polyamideimide resin; and an aerogel dispersed in the polyamideimide resin. In particular, the thermal insulation coating layer may have a thermal conductivity of about 0.60 W/mK or less.

The thermal insulation coating layer may have a thermal capacity of about 1250 KJ/m³*K or less.

The polyamideimide resin may be present in an amount of about 2 wt % or less in an inner part of the aerogel.

The polyamideimide resin may not be present in a depth corresponding to about 5% or greater of the longest diameter from a surface of the aerogel.

Each aerogel may have a porosity of about 92% to 99% when the aerogels are dispersed in the polyamideimide resin.

The thermal insulation coating layer may have a thickness of about 50 μm to 500 μm.

The thermal insulation coating layer may be formed on inner surfaces or components of an internal combustion engine.

The aerogel may be included in an amount of about 5 to 50 parts by weight based on 100 parts by weight of the polyamideimide resin.

Further provided are internal combustion engines that comprise the thermal insulation coating layer formed with the composition as described herein. Still further provided are vehicles that comprise the internal combustion engines coated with the thermal insulation coating layer of the invention.

Other aspects of the invention are disclosed infra.

### BRIEF DESCRIPTION OF THE DRAWINGS

FIG. 1 shows a photographic view of a surface of an exemplary thermal insulation coating layer obtained by Example 1 according to an exemplary embodiment of the present invention.

FIG. 2 shows a photographic view of a surface of a coating layer obtained by Comparative Example 2.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the thermal insulation coating composition and the thermal insulation coating layer according to various exemplary embodiments of the present invention will be described in more detail.

In an exemplary embodiment of the present invention, a thermal insulation coating composition may include: a polyamideimide resin dispersed in a first organic solvent or in an aqueous solvent; and an aerogel dispersed in a second organic solvent. Particularly, the first organic solvent may have a boiling point equal to or greater than 110° C. and the second organic solvent may have a boiling point less than about 110° C.

As such, the coating composition may be obtained by dispersing a polyamideimide resin and an aerogel in the first and the second organic solvent, respectively, and mixing them with each other. The coating layer obtained therefrom may have reduced thermal conductivity and density and improved mechanical physical properties and thermal resistance. Accordingly, the coating layer comprising the coating composition may be applied to an internal combustion engine to reduce thermal energy discharged to the outside, thereby improving efficiency of the internal combustion engine and fuel efficiency of an automobile.

In the related art, methods of using an aerogel or air-gel such as insulation materials, shock-absorbing materials, soundproofing materials, or the like, have been introduced in recent years. The aerogel may have a structure which consists of a tangle of fine fibers each having a thickness corresponding to about 1/10,000 of a hair, and may have a porosity of about 90% or greater. The aerogel may include silicon oxide, carbon, or organic polymer as main materials. In particular, the aerogel may be a substantially reduced-density material having increased translucency and ultra-low thermal conductivity due to the above-described structural characteristics.

Meanwhile, the aerogel may be substantially fragile and have reduced strength, and thus may be easily broken with a minor stress. Accordingly, the aerogel has not been be processed into various thicknesses and shapes and applied as the thermal insulation materials, although it has substantial thermal insulation property. In addition, when the aerogel is mixed with other reactants, solvent or solute may be permeated into an inner part of the aerogel to increase viscosity of a compound, such that the mixing may not be obtained suitably, complex or mixture with other materials may not be formed and properties of porous aerogel may not be sufficiently obtained.

According to an exemplary embodiment of the present invention, in the thermal insulation coating composition, the polyamideimide resin may be dispersed in the first organic solvent or in the aqueous solvent, and the aerogel may be dispersed in the second organic solvent. In particular, the first and the second organic solvent may have different ranges of boiling point, for example, the first organic solvent may have a boiling point equal to or greater than about 110° C. and the second organic solvent may have a boiling temperature less than about 110° C. Accordingly, the solvent-dispersed phase of the polyamideimide resin and the solvent-dispersed phase of the aerogel may not be agglomerated but uniformly mixed with each other, and the thermal insulation coating composition may also have uniform composition.

In addition, since the first organic solvent or the aqueous solvent and the second organic solvent may not be easily dissolved or mixed with each other, when the polyamideimide resin dispersed in the first organic solvent or the aqueous solvent and the aerogel dispersed in the second organic solvent may be mixed to form a coating composition, direct contact between the polyamideimide resin and the aerogel may be minimized until the thermal insulation coating composition is applied and dried. Particularly, the polyamideimide resin may be prevented from being permeated or impregnated into the inner part or pores of the aerogel.

Further, the second organic solvent may have a predetermined affinity with the first organic solvent or the aqueous solvent, such that the aerogel dispersed in the second organic solvent may be physically mixed with the polyamideimide resin dispersed in the first organic solvent or the aqueous solvent to be uniformly distributed therein, and the polyamideimide resin may be uniformly distributed into the first organic solvent or the aqueous solvent.

Accordingly, in the thermal insulation coating layer obtained from the thermal insulation coating composition according to an exemplary embodiment of the present invention, physical properties of the aerogel may be improved to be at an equivalent level or greater compared to a conventional insulation coating layer, and the aerogel may be more uniformly dispersed in the polyamideimide resin, such that improved thermal insulation property in addition to high mechanical physical properties and thermal resistance may be obtained. In other words, as described above, the thermal insulation coating layer obtained from the thermal insulation coating composition according to an exemplary embodiment of the present invention may maintain the physical properties and the structure due to the aerogel to be an equivalent level, such that reduced thermal conductivity and reduced density may be provided, as well as the improved mechanical physical property and thermal resistance. Accordingly, when the thermal insulating coating layer is applied to the internal combustion engine, thermal energy discharged to the outside may be reduced to improve efficiency of the internal combustion engine and fuel efficiency of the automobile.

Meanwhile, the thermal insulation coating composition according to an exemplary embodiment of the present invention may be formed by mixing the polyamideimide resin dispersed in the first organic solvent or the aqueous solvent; and the aerogel dispersed in the second organic solvent as described above.

Mixing methods may not be limited, and any physical mixing methods that are generally known may be used without limitation. For example, two kinds of solvent-dispersed phase may be mixed with each other and zirconia beads may be added thereto. The mixture may be processed by ball milling under conditions of room temperature and atmosphere pressure at a speed of about 100 to 500 rpm, to prepare the coating composition (coating solution). Meanwhile, the method of mixing the solvent-dispersed phase of the polyamideimide resin with the solvent-dispersed phase of the aerogel may not be limited to the above-described example.

The thermal insulation coating composition may provide thermal insulation materials, thermal insulation structures, and the like, such that the thermal insulation coating composition may be maintained in the internal combustion engine under repeated high temperature and high pressure conditions for an extended time, and particularly, the thermal insulation coating composition of the present invention may be used for coating inner surfaces or components of the internal combustion engine.

The polyamideimide resin which may be included in the thermal insulation coating composition according to an exemplary embodiment of the present invention may not be limited in view of an example, and the polyamideimide resin may have a weight average molecular weight of about 3,000 to 300,000, or particularly of about 4,000 to 100,000.

When the polyamideimide resin has weight average molecular weight less than a predetermined value, for example, less than about 3,000, mechanical physical properties or thermal resistance and thermal insulation property of a coating layer, a coating film or a coating layer obtained from the thermal insulation coating composition may not be sufficient, and further the polymer resin may be easily permeated into the inner part of the aerogel. In addition, when the polyamideimide resin has weight average molecular weight greater than a predetermined value, for example, greater than about 300,000, uniformity or homogeneity of the coating layer, the coating film, or the coating layer obtained from the thermal insulation coating composition may be deteriorated and dispersibility of the aerogel in the thermal insulation coating composition may be deteriorated. Further, nozzle, and the like, of an applying apparatus at the time of applying the thermal insulation coating composition may not be used suitably, time required for thermal treating the thermal insulation coating composition may be extended, and thermal treatment temperature may be increased.

As the aerogel, general aerogels that are generally known in the art may be used. As the aerogel, silicon oxide, carbon, polyimide, metal carbide or mixtures of two or more thereof may be used without limitation.

The aerogel may have a specific surface area from about 100 cm²/g to about 1,000 cm²/g or from about 300 cm²/g to about 900 cm²/g.

In the thermal insulation coating composition, the aerogel may be included in an amount of about 5 to 50 parts by weight or in an amount of about 10 to 45 parts by weight based on 100 parts by weight of the polyamideimide resin. A weight ratio between the polyamideimide resin and the aerogel is may be a weight ratio of a solid content thereof except for the dispersion solvent.

When the content of the aerogel to the polyamideimide resin is less that a predetermined amount, for example, less than about 5 part by weight, thermal conductivity and density of the coating layer, the coating film, or the coating layer obtained from the thermal insulation coating composition may not be reduced sufficiently, sufficient thermal insulation property may not be obtained, and thermal resistance of the thermal insulation film manufactured from the thermal insulation coating composition may be reduced. In addition, when the content of the aerogel to the polymer resin is greater than about a predetermined amount, for example, greater than about 50 parts by weight, sufficient mechanical physical properties of the coating layer, the coating film, or the coating layer obtained from the thermal insulation coating composition may not be obtained, and crack may occur in the thermal insulation film manufactured from the thermal insulation coating composition, or a coated film shape of the thermal insulation film may not be firmly maintained.

A solid content of the polyamideimide resin in the first organic solvent or the aqueous solvent may not be limited, and the solid content thereof may be included in an amount of about 5 wt % to 75 wt % based on the total weight of the 1) the high boiling point organic solvent or the aqueous solvent and 2) the polyamideimide resin for improving uniformity or physical properties of the thermal insulation coating composition.

In addition, a solid content of the aerogel in the second organic solvent may not be limited, and the solid content of the aerogel may be of about 5 wt % to 75 wt % based on the total weight of the aerogel and the low boiling point organic solvent for improving uniformity and physical properties of the thermal insulation coating composition.

As described above, since the first organic solvent or the aqueous solvent and the second organic solvent are not easily dissolved or mixed with each other, direct contact between the polyamideimide resin and the aerogel may be minimized until the thermal insulation coating composition is applied and dried, and the polyamideimide resin may be prevented from being permeated or impregnated into the inner part or the pores of the aerogel.

Particularly, a difference in boiling point between the first organic solvent and the second organic solvent may be 10° C. or greater, or 20° C. or greater, or in a range of about 10 to 200° C.

As the first organic solvent, organic solvents having a boiling point of about 110° C. or greater may be particularly used.

The first solvent may include anisole, toluene, xylene, methyl ethyl ketone, methyl isobutyl ketone and ethylene glycol monomethyl ether, ethylene glycol monoethyl ether, ethylene glycol monobutyl ether, butyl acetate, cyclohexanone, ethylene glycol monoethyl ether acetate (BCA), benzene, hexane, DMSO, N,N′-dimethylformamide or mixtures of two or more kinds thereof.

As the second organic solvent, organic solvents having a boiling point less than about 110° C. may be particularly used.

The second organic solvent may include methyl alcohol, ethyl alcohol, propyl alcohol, n-butyl alcohol, iso-butyl alcohol, tert-butyl alcohol, acetone, methylene chloride, ethylene acetate, isopropyl alcohol or mixtures of two or more kinds thereof.

Meanwhile, the aqueous solvent may include water, methanol, ethanol, ethyl acetate, or mixtures of two or more kinds thereof.

Moreover, thermal insulation coating layer including the polyamideimide resin and the aerogel dispersed in the polyamideimide resin may have a thermal conductivity of about 0.60 W/mK or less.

As described above, the thermal insulation coating layer may have reduced thermal conductivity and reduced density; and improved mechanical physical properties and thermal resistance. Further, the thermal insulation coating layer may be applied to the internal combustion engine to reduce thermal energy discharged to the outside, thereby improving efficiency of the internal combustion engine and fuel efficiency of the vehicle using the above-described thermal insulation coating composition.

In the thermal insulation coating layer, the aerogel may be uniformly dispersed throughout the entire area of the polyamideimide resin, and therefore, physical properties implemented from the aerogel, for example, reduced thermal conductivity and reduced density may be substantially obtained, and properties originated from the polyamideimide resin, for example, substantial mechanical physical properties, thermal resistance, and the like, may be implemented as much as the coating layer using only the polyamideimide resin.

The thermal insulation coating layer may have a reduced thermal conductivity and a substantial thermal capacity, and particularly, the thermal insulation coating layer may have a thermal conductivity of about 0.60 W/mK or less, or about 0.55 W/mK or less, or of about 0.60 W/mK to 0.200 W/mK. In addition, the thermal insulation coating layer may have a thermal capacity of about 1250 KJ/m³*K or less, or of about 1000 to 1250 KJ/m³ K.

Meanwhile, as described above, the thermal insulation coating composition may include the polyamideimide resin dispersed in the first organic solvent or in the aqueous solvent; and the aerogel dispersed in the second organic solvent to minimize the direct contact between the polyamideimide resin and the aerogel until the thermal insulation coating composition is applied and dried, such that the polyamideimide resin may not be permeated or impregnated into the inner part or the pores of the aerogel included in the thermal insulation coating layer finally manufactured.

Particularly, the polyamideimide resin may not be substantially present in the inner part of the aerogel dispersed in the polyamideimide resin, and for example, the polyamideimide resin may be present at about 2 wt % or less or about 1 wt % or less in the inner part of the aerogel.

In addition, the aerogel in the thermal insulation coating layer may be present when the aerogel is dispersed in the polyamideimide resin. In other words, an outer part of the aerogel may contact or may be combined with the polyamideimide resin; however, the inner part of the aerogel may not have the polyamideimide resin. Particularly, the polyamideimide resin may not be present in a depth corresponding to about 5% or greater of the longest diameter from a surface of the aerogel included in the thermal insulation coating layer.

Since the polyamideimide resin is not permeated or impregnated into the inner part or the pores of the aerogel, the aerogel may have an equivalent level of porosity before and after the polyamideimide resin is dispersed, and particularly, each aerogel included in the thermal insulation coating layer may have a porosity of about 92% to 99% when the aerogels are dispersed in the polyamideimide resin.

The thermal insulation coating layer may provide thermal insulation materials, thermal insulation structures, and the like, capable of being maintained in the internal combustion engine under repeated high temperature and high pressure conditions for an extended time. Accordingly, the thermal insulation coating layer may be formed on the internal surfaces or the components of the internal combustion engine.

A thickness of the thermal insulation coating layer may be determined depending on fields or positions to be applied or physical properties to be desired, and for example, may be of about 50 μm to 500 μm.

In the thermal insulation coating layer, the aerogel may be included in an amount of about 5 to 50 parts by weight or particularly of about 10 to 45 parts by weight based on 100 parts by weight of the polyamideimide resin.

When the content of the aerogel to the polyamideimide resin is less than the predetermined amount, for example, less than about 5 parts by weight, thermal conductivity and density of the thermal insulation coating layer may not be reduced sufficiently, sufficient thermal insulation property may not be obtained, and thermal resistance of the thermal insulation coating layer may be reduced. In addition, when the content of the aerogel to the polymer resin is greater than the predetermined amount, for example, greater than about 50 parts by weight, sufficient mechanical physical properties of the thermal insulation coating layer may not be obtained, and crack may occur in the thermal insulation coating layer, or a coated film shape of the thermal insulation film may not be maintained firmly.

The polyamideimide resin may have a weight average molecular weight of about 3,000 to 300,000, or particularly of about 4,000 to 100,000.

The aerogel may include at least one compound selected from the group consisting of silicon oxide, carbon, polyimide, and metal carbide.

The aerogel may have a specific surface area from about 100 cm²/g to about 1,000 cm²/g.

The polyamideimide resin and the aerogel included in the thermal insulation coating composition as described above may be used in the thermal insulation coating layer.

Meanwhile, the thermal insulation coating layer according to an exemplary embodiment of the present invention may be obtained by drying the thermal insulation coating composition of the invention. Apparatuses or methods which may be used in drying the thermal insulation coating composition may not be limited, and but a naturally drying method over room temperature, a drying method by heating at a temperature of about 50° C. or greater, and the like, may be used without limitation.

For example, the thermal insulation coating composition may be coated on coated a substrate or a material, for example, an inner surface or an outer surface of the components of the internal combustion engine, and then, the coating composition may be semi-dried at a temperature of about 50° C. to 200° C. at least one time. Subsequently, and the semi-coated coating composition may be completely dried at a temperature of about 200° C. or greater to form the thermal insulation coating layer. Meanwhile, a specific method of applying the thermal insulation coating layer may not be limited thereto.

According to various exemplary embodiments of the present invention, the thermal insulation coating composition may have a reduced thermal conductivity and density; and substantially improved mechanical physical properties and thermal resistance. Accordingly, the thermal insulation coating layer comprising the thermal insulation coating composition as described above may be applied to an internal combustion engine to reduce thermal energy discharged to the outside, thereby improving efficiency of the internal combustion engine and fuel efficiency of a vehicle.

The exemplary embodiments will be described in more detail in the following examples. However, the following examples are to illustrate the exemplary embodiments, and the scope of the present invention is not limited to the following examples.

### Examples 1 to 3

(1) Preparation of Thermal Insulation Coating Composition

A porous silica aerogel having a specific surface area of about 500 cm²/g was dispersed in ethyl alcohol and a polyamideimide resin (Solvay Co.) having a weight average molecular weight of about 11,000 was dispersed in xylene. The prepared materials were injected into a 20 g reactor as zirconia beads (440 g) was added thereto, and subsequently ball milling was performed under conditions of room temperature and atmosphere pressure at a speed of about 150 to 300 rpm, to prepare a thermal insulation coating composition (a coating solution). A weight ratio of the porous silica aerogel to the polyamideimide resin is shown in Table 1.

(2) Formation of Thermal Insulation Coating Layer

The obtained thermal insulation coating composition was applied onto a piston for a vehicle by spray coating. In addition, after the thermal insulation coating composition was applied onto the piston, primary semi-drying was performed at temperature of about 150° C. for about 10 minutes. The thermal insulation coating composition was re-applied thereonto, and then secondary semi-drying was performed at a temperature of about 150° C. for about 10 minutes. After the secondary semi-drying, the thermal insulation coating composition was applied again and completely dried at a temperature of about 250° C. for about 60 minutes to form the thermal insulation coating layer on the piston. Also, a thickness of each coating layer is shown in Table 1.

### Comparative Example 1

A polyamideimide resin (Solvay Co.) having a weight average molecular weight: about 11,000 was dispersed in xylene. And, PAI solution (xylene solution of the polyamideimide resin) was applied onto the piston for the automobile engine by solution spray coating.

In addition, after the PAI solution was applied onto the piston, primary semi-drying was performed at a temperature of about 150° C. for about 10 minutes, and the PAI solution was re-applied thereonto. Then, secondary semi-drying was performed at a temperature of about 150° C. for about 10 minutes. After the secondary semi-drying, the PAI solution was re-applied and completely dried at a temperature of about 250° C. for about 60 minutes to form the thermal insulation coating layer on the piston. A thickness of the formed coating layer is shown in Table 1.

### Comparative Example 2

### (1) Preparation of Coating Composition

A porous silica aerogel having a specific surface area of about 500 cm²/g and a polyamideimide resin (Solvay Co.) having a weight average molecular weight of about 11,000 were dispersed in xylene and the resulting mixture were injected into a 20 g reactor with zirconia beads (440 g) added thereto. Subsequently, ball milling was performed under conditions of room temperature and atmosphere pressure at a speed of about 150 to 300 rpm, to prepare a coating composition (a coating solution).

A weight ratio of the porous silica aerogel to the polyamideimide resin is shown in Table 1.

(2) Formation of Thermal Insulation Coating Layer

A coating layer having a thickness of about 200 μm was formed as described in Example 1.

### Experimental Example

### 1. Experimental Example 1

### Thermal Conductivity Measurement

Thermal conductivity of the coating layers on the piston obtained by each of Examples and Comparative Examples was measured by thermal diffusion measuring method under conditions of room temperature and atmosphere pressure using a laser flash method in accordance with standard ASTM E1461.

### 2. Experimental Example 2

### Thermal Capacity Measurement

Thermal capacity of the coating layers on the piston obtained by each of Examples and Comparative Examples was confirmed by measuring specific heat under conditions of room temperature using a DSC apparatus having sapphire as a reference in accordance with standard ASTM E1269.

TABLE 1

| | Aerogel Content | | Thermal | Thermal |
|---|---|---|---|---|
| | (Parts by Weight) | Thickness | Conductivity | Capacity |
| | based on 100 Parts | (μm) of | [W/mK] of | [KJ/m³ K] of |
| | by Weight of | Coating | Coating | Coating |
| | PAI Resin | Layer | Layer | Layer |
| Example 1 | 15 | 120 | 0.54 | 1216 |
| Example 2 | 20 | 200 | 0.331 | 1240 |
| Example 3 | 40 | 200 | 0.294 | 1124 |
| Compara- | — | 200 | 0.56 | 1221 |
| tive | | | | |
| Example 1 | | | | |

As shown in Table 1 above, the thermal insulation coating layers obtained by Examples 1 to 3 may have a thermal capacity of about 1240 KJ/m³*K or less and thermal conductivity of about 0.54 W/mK or less at a thickness of about 120 to 200 μm. Accordingly, the thermal insulation coating layers obtained by Examples 1 to 3 may be applied to the internal combustion engine to reduce thermal energy discharged to the outside, thereby improving efficiency of the internal combustion engine and fuel efficiency of an automobile.

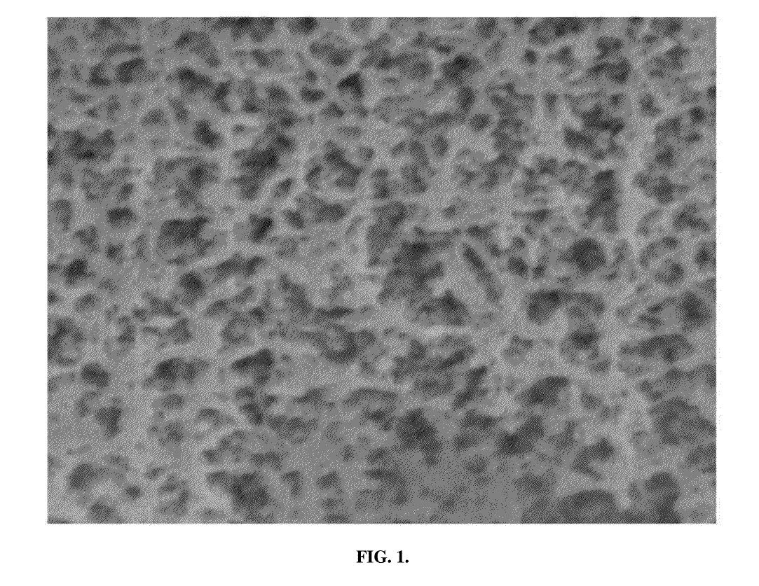

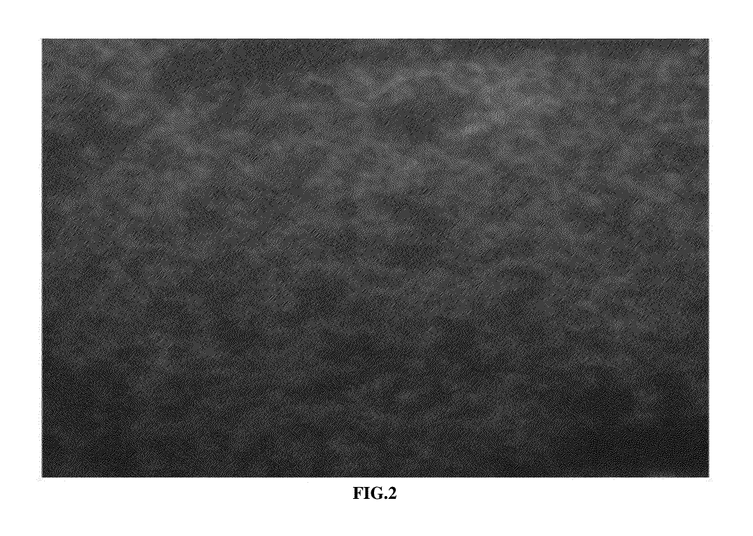

In addition, as shown in FIG. 1, the thermal insulation coating layer manufactured by Example 1, the polyamideimide resin may not be permeated into the inner part of the aerogel, and the aerogel may maintain inner pores to be about 92% or greater. On the contrary, in the coating layer manufactured by Comparative Example 2, the polyamideimide resin was permeated into the inner part of the aerogel, such that pores were rarely observed (FIG. 2).

What is claimed is:

1. A thermal insulation coating composition comprising:
a polyamideimide resin dispersed in a first organic solvent or in an aqueous solvent; and
an aerogel dispersed in a second organic solvent.

2. The thermal insulation coating composition of claim 1, wherein the thermal insulation coating composition is used for coating inner surfaces or components of an internal combustion engine.

3. The thermal insulation coating composition of claim 1, wherein the polyamideimide resin has a weight average molecular weight of about 3,000 to 100,000.

4. The thermal insulation coating composition of claim 1, wherein the aerogel includes at least one compound selected from the group consisting of silicon oxide, carbon, polyimide, and metal carbide.

5. The thermal insulation coating composition of claim 1, wherein the aerogel has a specific surface area from about 100 cm²/g to 1,000 cm²/g.

6. The thermal insulation coating composition of claim 1, wherein the aerogel is included in an amount of about 5 to 50 parts by weight based on 100 parts by weight of the polyamideimide resin.

7. The thermal insulation coating composition of claim 1, wherein the polyamideimide resin in the first organic solvent or in the aqueous solvent has a solid content of about 5 wt % to 75 wt % based on the total weight of 1) the high boiling point organic solvent or the aqueous solvent and 2) the polyamideimide resin.

8. The thermal insulation coating composition of claim 1, wherein the aerogel in the second organic solvent has a solid content of about 5 wt % to 75 wt % based on the total weight of the aerogel and the low boiling point organic solvent.

9. The thermal insulation coating composition of claim 1, wherein a difference in boiling point between the first organic solvent and the second organic solvent is about 10° C. or greater.

10. The thermal insulation coating composition of claim 9, wherein the first organic solvent has a boiling point of about 110° C. or greater.

11. The thermal insulation coating composition of claim 1, wherein the first organic solvent includes at least one selected from the group consisting of anisole, toluene, xylene, methyl ethyl ketone, methyl isobutyl ketone and ethylene glycol monomethyl ether, ethylene glycol monoethyl ether, ethylene glycol monobutyl ether, butyl acetate, cyclohexanone, ethylene glycol monoethyl ether acetate (BCA), benzene, hexane, and N,N′-dimethylformamide.

12. The thermal insulation coating composition of claim 9, wherein the second organic solvent has a boiling point less than about 110° C.

13. The thermal insulation coating composition of claim 1, wherein the second organic solvent includes at least one selected from the group consisting of methyl alcohol, ethyl alcohol, propyl alcohol, n-butyl alcohol, iso-butyl alcohol, tert-butyl alcohol, acetone, methylene chloride, ethylene acetate and isopropyl alcohol.

14. The thermal insulation coating composition of claim 1, wherein the aqueous solvent includes at least one selected from the group consisting of water, methanol, ethanol and ethyl acetate.

15. A thermal insulation coating layer comprising: a polyamideimide resin; and an aerogel dispersed in the polyamideimide resin, wherein the thermal insulation coating layer has a thermal conductivity of about 0.60 W/mK or less.

16. The thermal insulation coating layer of claim 15, wherein the thermal insulation coating layer has a thermal capacity of about 1250 KJ/m³*K or less.

17. The thermal insulation coating layer of claim 15, wherein the polyamideimide resin is present at about 2 wt % or less in an inner part of the aerogel.

18. The thermal insulation coating layer of claim 15, wherein the polyamideimide resin is not present in a depth corresponding to 5% or greater of a longest diameter from a surface of the aerogel.

19. The thermal insulation coating layer of claim 15, wherein each aerogel has a porosity of about 92% to about 99% when the aerogels are dispersed in the polyamideimide resin.

20. The thermal insulation coating layer of claim 15, wherein the thermal insulation coating layer has a thickness of about 50 μm to 500 μm.

21. The thermal insulation coating layer of claim 15, wherein the thermal insulation coating layer is formed on inner surfaces or components of an internal combustion engine.

22. The thermal insulation coating layer of claim 15, wherein the aerogel is included in an amount of about 5 to 50 parts by weight based on 100 parts by weight of the polyamideimide resin.

23. An internal combustion engine comprising a thermal insulation coating layer of claim 15.

24. A vehicle comprising an internal combustion engine of claim 23.
